(19) United States
(12) Patent Application Publication
(10) Pub. No.: US 2003/0214602 A1
(43) Pub. Date: Nov. 20, 2003

(54) Camera docking system with multiple controls

(76) Inventors: Amy E. Battles, Windsor, CO (US); James C. Dow, Fort Collins, CO (US); Daniel J. Byrne, Fort Collins, CO (US); James C. Albritton-McDonald, Bellvue, CO (US); Mark John Bianchi, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/146,282

(22) Filed: May 14, 2002

(51) Int. Cl. H04N 5/225; H04N 5/228

(52) U.S. Cl. 348/375; 348/376; 348/207.1; 348/207.2

(57) ABSTRACT

A camera docking system comprises a camera and a docking station. The docking station accepts connections from multiple external devices in addition to the camera itself and a power connection. The docking station has multiple controls that the user can actuate to initiate interactions between the camera and the other devices, each control corresponding to a device. At least some of the interactive functions can be accomplished without a computer attached or active. The docking system may optionally detect what devices are connected and indicates the operability of corresponding controls.

### FIELD OF THE INVENTION

The present invention relates generally to digital photography.

### BACKGROUND OF THE INVENTION

A digital camera typically uses a lens, an electronic array light sensor, and other electronics to obtain a digital photograph of a scene. A digital photograph is a collection of digital data that represent the color and brightness of picture elements, or “pixels”, that correspond to locations within the scene. The camera typically stores digital photographs in some electronic storage medium within the camera. This medium may be nonvolatile memory, such as flash memory or a similar type of memory, a magnetic disk such as a floppy disk, or an optical disk such as a CD-RW disk. Some nonvolatile memory may be built into the camera, and the camera may accept memory “cards” with additional storage space.

Many cameras include a viewing screen that can display the digital photographs taken by the camera. Controls allow the user to select which photograph or photographs to display. However, even though it is possible to display the photographs on the camera's display screen, most users wish to use their digital photographs in other ways. A camera user may wish to print his or her photographs on paper, display them on a computer screen or other display, display them on a television monitor, share them with someone else using a computer network such as the Internet, edit or store them on a computer, or may have some other use for the photographs that requires transporting them out of the camera.

Digital cameras are typically battery-powered portable devices. Often, rechargeable batteries are used to minimize cost and environmental effects. These batteries require recharging periodically, typically after a few hours of use.

Some digital cameras, to facilitate their use, have companion accessories called “docking stations.” A docking station provides a storage place for the camera when the camera is not in use for picture taking, but also performs other functions. The camera typically rests in the docking station and attaches to it through an electrical connector. The electrical connector may carry both power and various communication signals. Placing the camera in the docking station is typically more convenient than reconnecting cables as would be required to connect the camera to power and other devices without the aid of a docking station.

The docking station in turn may connect to a mains power outlet and to one or more other devices such as a computer, printer, or television monitor. The mains power connection provides power for operating the docking station itself, and the docking station may also pass power to the camera for charging the camera's batteries and for powering the camera during docked operation.

Besides connecting to a power source, some docking stations connect only to a single other device, often a computer. Software on the computer may communicate with the camera through the docking station to retrieve or view the digital photographs stored in the camera. Alternatively, the docking station may have a user-operable button for initiating interaction between the computer and the camera. For example, the user may mount the camera on the docking station and press the button on the docking station, initiating an automatic sequence of transferring the digital photographs in the camera to storage in the computer.

Other docking stations may connect to more than one device, for example a computer and a television monitor. Docking stations of this type typically default to a pre-programmed behavior depending on what devices are connected, or require that a computer be connected and active to select operations. For example, if the docking station detects that a television monitor is connected, then digital photographs may be displayed on the television monitor by default. If a computer is connected, it may retrieve digital photographs from the camera under software control.

There is a need for a camera docking station that allows the connection of multiple other devices, provides convenient function selection to the user, and can perform at least some functions without a computer connection.

### SUMMARY OF THE INVENTION

A camera docking system comprises a camera and a docking station. The docking station accepts connections from multiple external devices in addition to the camera itself and a power connection. The docking station has multiple controls that the user can actuate to initiate interactions between the camera and the other devices, each control corresponding to a device. At least some of the interactive functions can be accomplished without a computer attached or active. The docking system may optionally detect what devices are connected and indicates the operability of corresponding controls.

### BRIEF DESCRIPTION OF THE DRAWINGS

FIG. 1 depicts a camera on an example camera docking station.

FIG. 1a depicts icons on the buttons of the example docking station.

FIG. 2 depicts an example camera docking station without the camera attached.

FIG. 3 depicts the electrical connectors available on an example camera docking station.

FIG. 3a shows a close-up view of the connectors in FIG. 3.

FIG. 4 is a simplified block diagram of the electronics in an example embodiment of the docking station.

### DETAILED DESCRIPTION OF THE PREFERRED EMBODIMENT

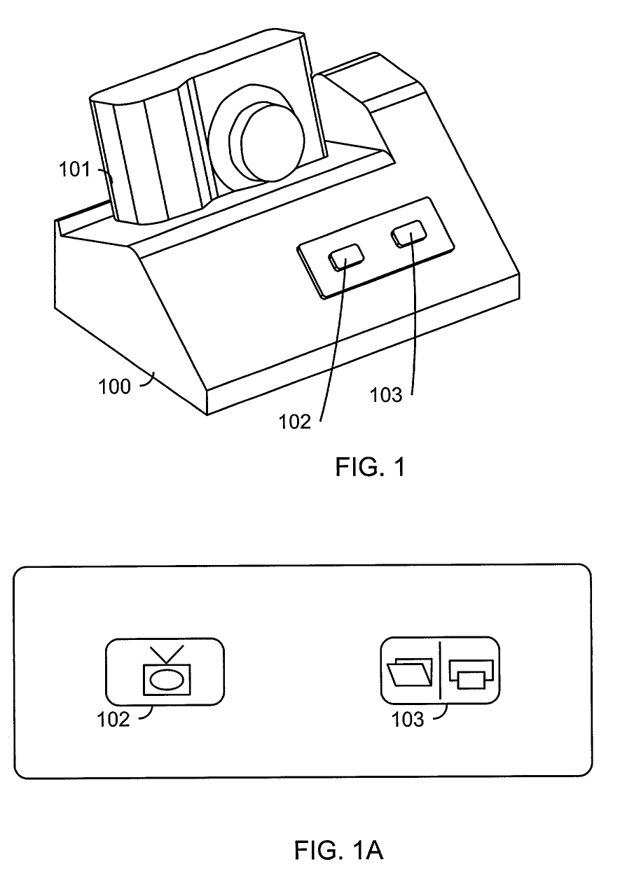

FIG. 1 depicts an example camera system comprising a docking station (100) with a camera (101) attached. The docking station includes two buttons (102, 103) for initiating operations. Each button may be marked with an icon or other marking to indicate what operation or operations may be initiated with it, as depicted in more detail in FIG. 1a. In FIG. 1a, button (102) has an icon depicting a television monitor. Button (103) has an icon depicting both a computer file (represented by a filing folder), and a printer.

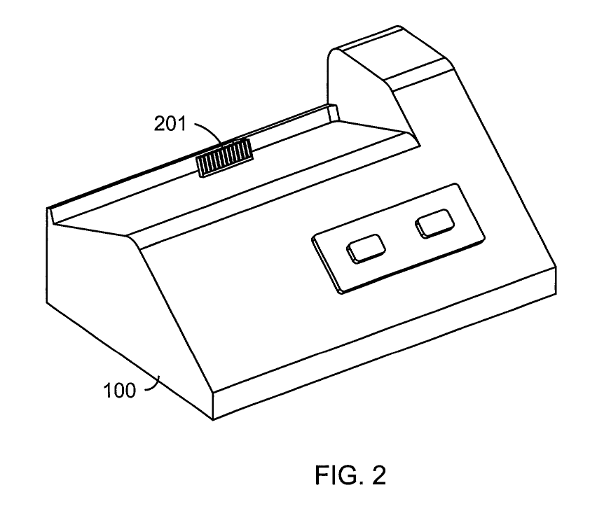

FIG. 2 depicts the camera docking station (100) without a camera attached. A connector (201) is positioned such that when the camera is attached, multiple electrical connections are made between the docking station and the camera. Signals passing through the connector (201) may include power for charging the camera's batteries, digital communication signals, audio and video, or other signals.

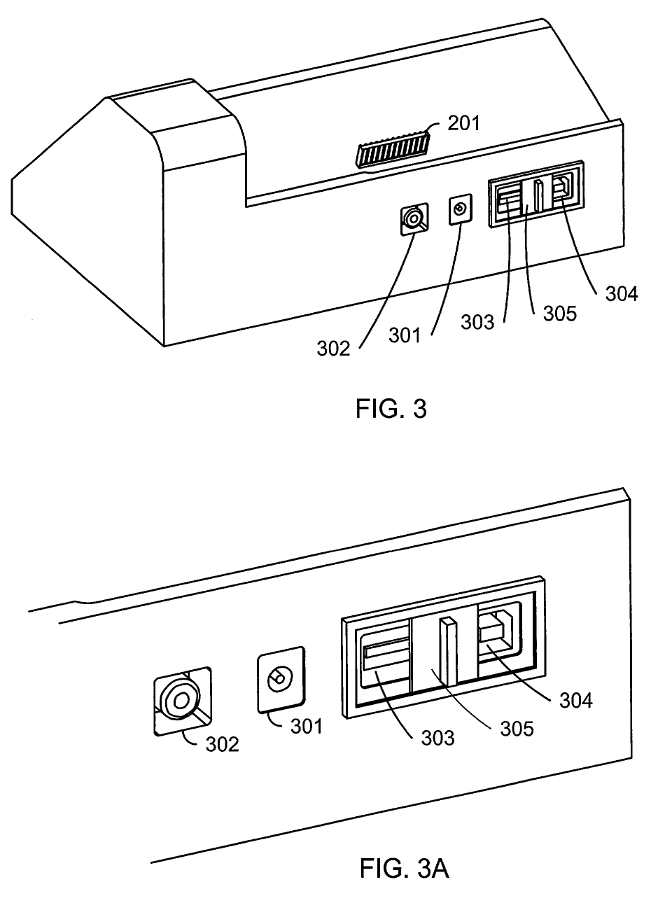

FIG. 3 depicts a set of electrical connections that may be available in an example docking station for connecting to power and to other devices external to the docking station. These connections are shown in greater detail in FIG. 3a. Power connector (301) receives power from an external source. Typically, a small transformer is plugged into a wall receptacle and supplies low voltage AC or DC power through a cable with an appropriate mating connector for power connector (301), although other combinations are possible. For the purposes of this disclosure, a power source is not considered to be a “device” connected to the docking system.

Audiovideo connector (302) may provide a composite video signal or separate video and audio signals through an appropriate cable to a television monitor. In this example embodiment, audiovideo connector (302) corresponds to button (102).

First USB connector (303) provides a “host” Universal Serial Bus connection for connecting a printer or other output device through an appropriate cable. When this connector (303) is used, the docking system is a USB host and controls a printer or other output device as a peripheral.

Second USB connector (304) provides a “peripheral” Universal Serial Bus connection for connecting to a computer through an appropriate cable. When this connector (304) is used, the docking system is a peripheral, and is controlled by the host computer (not shown).

In this example embodiment, USB connectors (303) and (304) correspond to button (103).

Sliding door (305) prevents both USB connectors (303, 304) from being used at the same time. The USB specification prohibits any single device from being both a host and a peripheral, so using both connectors is forbidden in this example embodiment. Other embodiments are possible wherein the docking station (100) could be connected to both a computer and a printer at the same time. For example, the docking station could be a USB hub, or another interface type could be used that permits peer-to-peer connection, such as the IEEE 1394 “Firewire” interface.

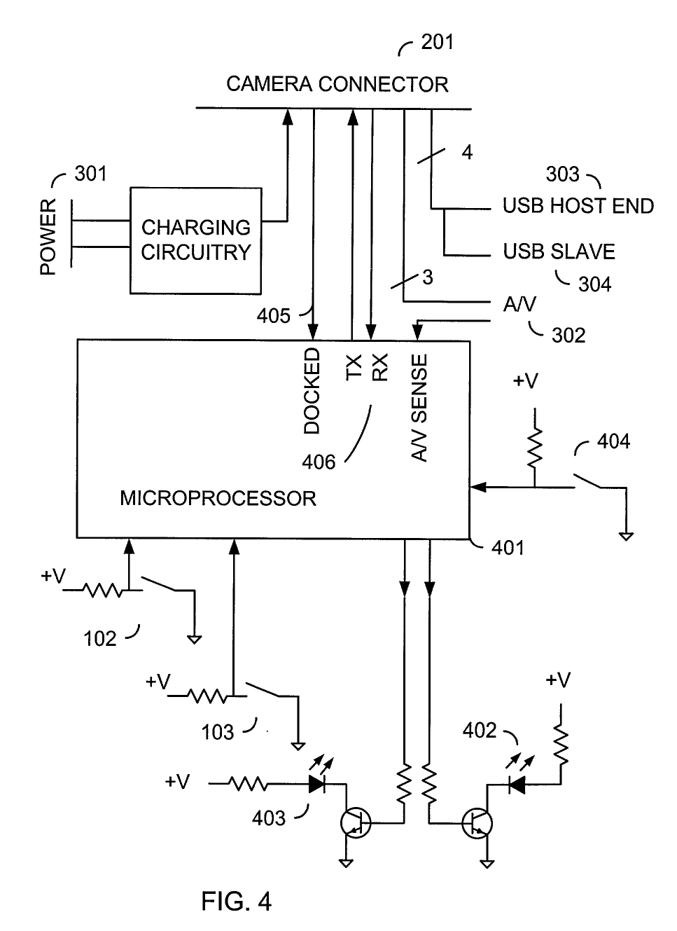

FIG. 4 is a simplified block diagram of the electronics inside an example docking station (100). The routing of power and ground signals is omitted from the diagram for clarity. A microprocessor (401) senses actuations of the control buttons (102, 103), and controls two light emitting diodes (402, 403) that illuminate the buttons in response to commands from the camera (101). The microprocessor (401) may also sense the position, using switch (404), of sliding door (305). A signal (405) from the camera connector (201) may indicate to the microprocessor that a camera is attached to the docking station.

Audiovideo data may be passed from the camera (101) through the camera connector (201) to the audiovideo connector (302).

An external power source is connected to the power connector (301), and conditioned power is passed to the camera (101) through the camera connector (201). Power is also routed throughout the electronics of the docking station (100).

The microprocessor (401) inside the docking station (100) may communicate with the camera through a Universal Asynchronous Receiver Transmitter (UART), indicated in FIG. 4 by transmit and receive lines Tx and Rx (406).

A Universal Serial Bus (USB) is routed through the docking station (100) to the USB host connector (303) and the USB peripheral connector (304).

Assuming that a camera is connected to the docking station through connector (201) and power is supplied through power connector (301), six combinations of interface connections are possible during operation of the example docking system. The USB host connector (303) may be used to connect the docking station to a peripheral, the USB peripheral connector (304) may be used to connect the docking station to a computer, or neither may be connected. In each of these cases, the audiovideo connector (302) may be used to connect the docking station to a television monitor, or left unconnected. One of these six configurations is the situation in which neither of the USB connectors (303, 304) is used and no connection is made to the audiovideo connector (302). In this case, the docking station may be used simply to store the camera (101) or to store the camera (101) and recharge its batteries.

In the other cases, the docking system may detect which connectors are in use. The corresponding button on the front of the docking station may be illuminated to notify the user as to which buttons are active. When the user presses an active button, a prescribed function is performed.

For example, when the docking station detects (A/V SENSE) that a cable is connected to the audiovideo connector (302), the station may illuminate the corresponding button (102). When the user presses button (102), the docking station may communicate to the camera (101) using the UART (406) that an audiovideo cable is in place and that button (102) has been pressed. The camera (101) may proceed to sequentially display the digital photographs in its memory through its video connection to the audiovideo connector (301). The sequential “slide show” will then be viewable on any active television monitor connected to the audiovideo connector (301).

Alternatively, upon notice that button (102) has been pressed, the camera (101) may display a menu or setting screen that allows the user to specify how photographs are to be displayed before starting the sequential slide show. For example, the user may designate particular photographs in the camera's memory to be included in the slide show, may specify the amount of time each photograph is to be displayed, or may specify other settings. The slide show may be initiated by a control on the camera (101), or by another pressing of button (102).

When the docking station detects that the position of the sliding door (305), as indicated by switch (404), is such that the USB host connector (303) may be used, the docking station may send a message to the camera using the UART (406) indicating this condition. When the camera (101) detects that a printer or other peripheral is connected to the USB host connector (303), the camera (101) may send a message using the UART (406) to the docking station requesting the docking station to illuminate the corresponding button (103). When the user presses button (103), the docking station may report the button press event to the camera (101) using the UART (406) and the camera (101) may send designated digital photographs to the peripheral.

For example, the camera (101) may print a set of designated photographs to a connected printer. The camera (101) may provide means, such as a setup screen or menu, for designating which photographs are to be printed, what size they should be printed, what kind of paper is being used in the printer, or other parameters. In this way, digital photographs may be printed without the need for a computer. If a setup screen is launched upon pressing of button (103), the printing of the photographs may be initiated by a control on the camera (101) or by an additional pressing of button (103).

When the docking station detects that the position of the sliding door (305), as indicated by switch (404), is such that the USB peripheral connector (304) may be used, the docking station may send a message to the camera using the UART (406) indicating this condition. When the camera detects that it is connected to a computer through the USB peripheral connecter (304), it may send a message using the UART (406) to the docking station requesting the docking station to illuminate corresponding button (103). When the user presses button (103), the docking station may report the button press event to the camera using the UART (406), and the camera may send the digital photographs from the camera's memory to the computer for storage in a predetermined location in the computer's storage system. Alternatively, the computer may launch software that allows the user to exercise more control over the transfer. For example, the software may allow the user to change the location to which the photographs will be stored, view low-resolution “thumbnails” of the photographs and designate only some for storage, or control other aspects of the transfer.

The example embodiment described above illuminates buttons on the docking station when a corresponding device is connected, thereby indicating the operability of those buttons. The docking system may use other means as well. For example, an inactive button could retract or an active button could extend from the docking station so that operable buttons, those with corresponding devices connected, are more accessible than inoperable buttons. Alternatively, a signal light near a button could be illuminated rather than illuminating the button itself. It will be recognized that other means are possible for indicating the operability of a button. For the purposes of this disclosure, an operable button is one whose corresponding device is connected and the pressing of which will initiate an interaction.

The example embodiment described uses buttons for user control of interactions with external other devices, but it will be recognized that other types of controls may be used in place of or in addition to buttons. For example the user may actuate a switch, knob, capacitive sensor, or other control to initiate interaction with an external other device.

It will also be recognized that other docking systems embodying the invention may comprise more than one button or other control for each external other device. For example, two buttons or other controls may correspond to a computer connected to the docking system. One button or other control may initiate a transfer of digital photographs from the camera to the computer using pre-configured settings. The other button or other control may cause the computer to launch a software program for additional control over the transfer or for configuring future transfers.

The foregoing description of the present invention has been presented for purposes of illustration and description. It is not intended to be exhaustive or to limit the invention to the precise form disclosed, and other modifications and variations may be possible in light of the above teachings. For example, the docking station need not contain a microprocessor, as does the example embodiment used for illustration. The functions performed by the microprocessor in the example embodiment could be performed by the camera itself with an appropriate reconfiguration of the docking station and camera connections. While the example embodiment describes only two buttons and two external other devices, a docking system in accordance with the invention may accommodate more than two external devices and corresponding buttons. The example embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A camera docking system comprising:
a) a camera;
b) a docking station, connected to the camera, with connections for at least two external other devices; and
c) at least two controls on the docking station, each control corresponding to one of the at least two connections for external other devices, and the actuation of each control initiating interaction with its corresponding external other device connection when an external device is connected to that connection.

2. The camera docking system of claim 1 wherein the at least two connections for external other devices connect to a computer and a television monitor.

3. The camera docking system of claim 1 wherein the at least two connections for external other devices connect to a printer and a television monitor.

4. The camera docking system of claim 1 wherein the operability of each control is indicated when an external device is connected to the control's corresponding external device connection.

5. The camera docking system of claim 1 wherein actuating a control corresponding to a connection to television monitor causes the camera to display at least one digital photograph on the television monitor.

6. The camera docking system of claim 1 wherein actuating a control corresponding to a connection to a printer causes the camera to print at least one digital photograph on the printer.

7. The camera docking system of claim 1 wherein actuating a control corresponding to a connection to a computer causes the transfer of at least one digital photograph from the camera to the computer.

8. The camera docking system of claim 1 wherein actuating a control corresponding to a connection to a computer causes a program to be launched on the computer.

9. The camera docking system of claim 1 wherein the at least two controls are buttons.

10. The camera docking system of claim 1 wherein there are more controls than external other devices, at least one external other device having correspondence with at least two controls.

11. The camera docking system of claim 1 wherein the docking station further comprises a USB host connector and a USB peripheral connecter, one of the USB connectors being operable at a time.

12. The camera docking system of claim 11 wherein a first USB connector is rendered inoperable when a second USB connector is in use by making the first USB connector inaccessible.

13. A method of using a camera docking station comprising the steps of:
a) connecting at least one external other device to the docking station using at least one of at least two connectors provided on the docking station for connecting to external devices;
b) connecting a camera to the docking station; and
c) initiating interaction between the camera and an external other device by actuating one of at least two controls provided on the docking station, each control corresponding to one external other device connection.

14. A camera docking station comprising:
a) means for connecting a camera;
b) means for connecting at least two external other devices;
c) means for detecting the actuation of one of at least two controls provided on the docking station, each control corresponding to one external device connection; and
d) means for communicating to the camera that a control was actuated.

15. A method of operating a camera docking station comprising the steps of:
a) receiving a camera onto a camera docking station;
b) detecting at least one external device connected to one of at least two external device connections;
c) detecting the actuation of one of at least two controls, each control corresponding to one external device connection; and
d) initiating interaction with the external device.

16. The method of claim 15 further comprising the step of indicating the operability of a control when its corresponding external device is detected.

17. A camera docking system comprising:
a) a camera;
b) a docking station, connected to the camera, with connections for at least two external other devices; and
c) at least two controls on the docking station, each control corresponding to one of the at least two connections for external other devices, and each control becoming operable only when an external device is connected to its corresponding connection.

18. A camera docking system comprising:
a) means for connecting a camera;
b) means for connecting at least two external other devices;
c) means for detecting the presence of at least one external other device connected to one of the connections; and
d) means for indicating the operability of a control corresponding to a connection with an external other device.

19. A method of using a camera docking station comprising the steps of:
a) connecting at least two external devices;
b) connecting a camera;
c) detecting the presence of at least one external other device connected to the docking station; and
d) indicating the operability of a control corresponding to a connection with the external device.

20. A docking station comprising;
a) a sensor that detects whether a signal connector is accessible; and
b) signaling means for indicating to a camera a state of the sensor.

21. A docking station comprising:
a) a control switch;
b) a signal line that receives a signal from a camera; and
c) an indication designating whether the control switch is operable, in response to the signal from the camera.

22. A docking station comprising:
a) a connector for a camera;
b) at least two control switches;
c) at lest two connectors for devices, each connector for a device corresponding to one of the control switches; and
d) each control switch controlling whether the camera interacts with an external device.
